(19) United States
(12) Patent Application Publication
(10) Pub. No.: US 2014/0340750 A1
(43) Pub. Date: Nov. 20, 2014

(54) Cube Corner Retroreflector For Measuring Six Degrees of Freedom

(71) Applicant: FARO Technologies, Inc., Lake Mary, FL (US)

(72) Inventors: Robert Mark Neal, Cochranville, PA (US); Lawrence B. Brown, Cochranville, PA (US); Peter G. Cramer, West Chester, PA (US); Jonathan Robert Day, Wilmington, DE (US); Matthew Frederick Evans, Wyndmoor, PA (US); Aurelian Mavrodin, Mount Laurel, NJ (US)

(73) Assignee: FARO Technologies, Inc., Lake Mary, FL (US)

(21) Appl. No.: 14/257,263

(22) Filed: Apr. 21, 2014

Related U.S. Application Data
(63) Continuation-in-part of application No. 13/370,339, filed on Feb. 10, 2012, now Pat. No. 8,740,396.
(60) Provisional application No. 61/923,928, filed on Jan. 6, 2014.
(60) Provisional application No. 61/442,452, filed on Feb. 14, 2011.

(51) Int. Cl. G02B 5/122; B32B 37/12; B29D 11/00; B32B 37/18

(52) U.S. Cl. CPC G02B 5/122; B32B 37/18; B32B 37/12; B29D 11/00701; B32B 2305/22; B32B 2307/416; B32B 2307/408; B32B 2551/08; B29L 2011/0075
USPC 359/529; 216/24; 156/292; 264/400

(57) ABSTRACT

A target and method of manufacturing the target is provided. The method of manufacturing includes providing the cube cornered retroreflector, the cube cornered retroreflector including a first, second and third planar reflectors. Each planar reflector capable of reflecting light, each planar reflector perpendicular to the other two planar reflectors, each planar reflector intersecting the other two planar reflectors in a common vertex, and each planar reflector having two intersection junctions. Each intersection junction shared with an adjacent planar reflector for a total of three intersection junctions within the cube corner retroreflector. The method further including the step of directing ions from a focused ion beam etching (FIBE) device onto the first intersection junction defined by the first planar reflector and second planar reflector. A first material is removed from at least a first portion of the first intersection junction to define a first non-reflecting portion.

### CROSS REFERENCE TO RELATED APPLICATIONS

This application is a nonprovisional application of U.S. Provisional Application No. 61/923,928 filed on Jan. 6, 2014, the contents of which are incorporated by reference in its entirety. This application is further a continuation-in-part application of U.S. patent application Ser. No. 13/370,339 filed on Feb. 12, 2012, which claims priority to U.S. Provisional Application No. 61/442,452 filed on Feb. 14, 2011, the entire contents of which are incorporated herein by reference.

### FIELD OF INVENTION

The present invention relates in general to retroreflector targets and in particular to a cube corner retroreflector and a method of manufacturing a cube corner retroreflector that measures six degrees of freedom.

### BACKGROUND

There is a class of instruments that measures the coordinates of a point by sending a laser beam to a retroreflector target in contact with the point. The instrument determines the coordinates of the point by measuring the distance and the two angles to the target. The distance is measured with a distance-measuring device such as an absolute distance meter or an interferometer. The angles are measured with an angle-measuring device such as an angular encoder. A gimbaled beam-steering mechanism within the instrument directs the laser beam to the point of interest.

The laser tracker is a particular type of coordinate-measuring device that tracks the retroreflector target with one or more laser beams it emits. There is another category of instruments known as total stations or tachymeters that may measure a retroreflector or a point on a diffusely scattering surface. Laser trackers, which typically have accuracies on the order of a thousand of an inch and as good as one or two micrometers under certain circumstances, are usually much more accurate than total stations or scanners. The broad definition of laser tracker, which includes laser scanners and total stations, is used throughout this application.

Ordinarily the laser tracker sends a laser beam to a retroreflector target. A common type of retroreflector target is the spherically mounted retroreflector (SMR), which comprises a cube-corner retroreflector embedded within a metal sphere. The cube-corner retroreflector includes three mutually perpendicular mirrors. The vertex, which is the common point of intersection of the three mirrors, is located at the center of the sphere. Because of this placement of the cube corner within the sphere, the perpendicular distance from the vertex to any surface on which the SMR rests remains constant, even as the SMR is rotated. Consequently, the laser tracker can measure the 3D coordinates of a surface by following the position of an SMR as it is moved over the surface. Stating this another way, the laser tracker needs to measure only three degrees of freedom (one radial distance and two angles) to fully characterize the 3D coordinates of a surface.

Some laser trackers have the ability to measure six degrees of freedom (6 DOF), which may include three coordinates, such as x, y, and z, and three rotations, such as pitch, roll, and yaw. An exemplary system is described in U.S. Pat. No. 7,800,758 to Bridges, et al., incorporated by reference herein. This patent discloses a probe that holds a cube corner retroreflector, onto which marks have been placed. The cube corner retroreflector is illuminated by a laser beam from the laser tracker, and the marks on the cube corner retroreflector are captured by a camera within the laser tracker. The three orientational degrees of freedom, for example, the pitch, roll, and yaw angles, are calculated based on the image obtained by the camera. The laser tracker measures a distance and two angles to the vertex of the cube-corner retroreflector. When the distance and two angles are combined with the three orientational degrees of freedom obtained from the camera image, the position of a probe tip, arranged at a prescribed position relative to the vertex of the cube corner retroreflector, can be found. Such a probe tip may be used, for example, to measure the coordinates of a “hidden” feature that is out of the line of sight of the laser beam from the laser tracker.

Accordingly, while existing cube cornered retroreflectors and the methods of manufacturing the retroreflectors are suitable for their intended purposes the need for improvement remains, particularly in providing a method of forming nonreflective marks on the cube cornered retroreflector in a consistent, high yield and cost effective manner.

### SUMMARY

In accordance with an embodiment of the invention, A method of manufacturing a cube corner retroreflector is provided. The method includes: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; directing ions from a focused ion beam etching (FIBE) device onto the first intersection junction defined by the first planar reflector and second planar reflector; and removing a first material from at least a first portion of the first intersection junction to define a first non-reflecting portion.

In accordance with an embodiment of the invention, another method of manufacturing a cube corner retroreflector is provided. The method comprising: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; directing laser onto the first intersection junction defined by the first planar reflector and second planar reflector; and ablating a first material with the laser from at least a first portion of the first intersection junction to define a first non-reflecting portion.

In accordance with an embodiment of the invention, another method of manufacturing a cube corner retroreflector is provided. The method comprising: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; providing a micro-machining device having a cutting tip; positioning the cutting tip onto the first intersection junction defined by the first planar reflector and second planar reflector; and removing a first material with the cutting tip from at least a first portion of the first intersection junction to define a first non-reflecting portion.

In accordance with an embodiment of the invention, another method of manufacturing a cube corner retroreflector is provided. The method comprising: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; providing an optical fiber having a diameter; disposing the optical fiber onto the first intersection junction defined by the first planar reflector and second planar reflector; and disposing an adhesive layer between the optical fiber and the first intersection junction.

In accordance with an embodiment of the invention, still another method of manufacturing a cube corner retroreflector is provided. The method comprising: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; directing a cutting edge from a knife-edge die onto the first intersection junction defined by the first planar reflector and second planar reflector; and removing a first material with the cutting edge from at least a first portion of the first intersection junction to define a first non-reflecting portion.

In accordance with an embodiment of the invention, still another method of manufacturing a cube corner retroreflector is provided. The method comprising: providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction; applying a first non-reflective stripe to a first edge of the first plan reflector adjacent the first intersection junction, the first non-reflective stripe having a first width greater than the thickness of the second planar reflector; and applying a second non-reflective strip to the second planar reflector adjacent the first intersection junction, the second non-reflective stripe having a second width, the second width being smaller than the first width.

In accordance with another embodiment of the invention, a retroreflector is provided. The retroreflector including a first planar region, a second planar region and a third planar region. Each planar region is perpendicular to the other two planar regions and intersects the other two planar regions in a common vertex. A first intersection junction is defined between the first planar region and the second planar region, a second intersection junction is defined between the second planar region and the third planar region, and a third intersection junction is defined between the third planar region and the first planar region. The first planar region includes a first reflective portion and a first non-reflective portion. The second planar region includes a second reflective portion and a second non-reflective portion. The third planar region includes a third reflective portion and a third non-reflective portion. Wherein an interior volume bound at least in part by the first planar region, the second planar region, and the third planar region is filled with air. Wherein the first reflective portion has a first reflective layer, the second reflective portion has a second reflective layer, and the third reflective portion has a third reflective layer, the first reflective layer, the second reflective layer, and the third reflective layer being applied to a substrate structure. Wherein in the first non-reflective portion, the second non-reflective portion, and the third non-reflective portion, the substrate structure is in contact with the air of the interior volume, the first non-reflective portion, the second non-reflective portion, and the third non-reflective portion each including a recess surface that lies within the substrate structure.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a prior art illustration of an image of three lines from marks on a cube corner retroreflector, as obtained by a camera within a laser tracker;

FIG. 2 is an illustration of an image of three dark lines and three light lines from marks on a cube corner retroreflector, as obtained by a camera within a laser tracker;

FIGS. 3A-B illustrate production of a cube corner retroreflector by using a master element having varying radii at intersection junctions;

FIGS. 4A-B illustrate a glass cube corner having bevels at the intersection junctions;

FIGS. 5A-C are perspective, cross-sectional, and front views, respectively, of a target that includes an open-air cube-corner slug embedded within a sphere;

FIG. 5D is a perspective view of the target of FIGS. 5A-C with additional features;

FIGS. 6A-C are perspective, cross-sectional, and front views, respectively, of a target that includes a glass cube-corner embedded within a sphere;

FIG. 6D is a perspective view of the target of FIGS. 6A-C with additional features;

FIGS. 7A-B are perspective and front views, respectively, of the target of FIGS. 6A-C to which have been added marks on the top surface of the glass prism;

FIGS. 8A-C are perspective views of the target of FIGS. 5A-C to which have been added a reflective region, a bar-code pattern, and an RF identification tag, respectively;

FIG. 9 is a schematic illustration of a system for forming nonreflective marks on a cube cornered retroreflector;

FIG. 10 is a schematic illustration of an embodiment of a shaped nonreflective mark formed using the system of FIG. 9;

FIG. 11 is a side sectional view of a cube cornered retroreflector with a nonreflective mark formed using the system of FIG. 9;

FIG. 12 is an enlarged sectional view of FIG. 11;

FIG. 13 is a partial perspective view of a cube cornered retroreflector with a nonreflective mark formed using a micro-machining process;

FIG. 14 is a side sectional view of the micro-machining process of FIG. 14;

FIG. 15 is a partial perspective view of a cube cornered retroreflector with a nonreflective mark formed using a knife-edge stamping process;

FIG. 16 is a side sectional view of the knife-edge stamping process of FIG. 15;

FIG. 17 is a side sectional view of a cube cornered retroreflector having a nonreflective mark formed by an optical fiber;

FIG. 18 is an exploded perspective view of a cube cornered retroreflector in accordance with another embodiment of the invention; and

FIG. 19 is a perspective view of a cube cornered retroreflector of FIG. 18.

### DETAILED DESCRIPTION OF THE PREFERRED EMBODIMENTS

A cube corner retroreflector includes three planar reflectors that are mutually perpendicular. The three planar reflectors intersect at a common vertex, which in the ideal case is a point. Each of the planar reflectors has two intersection junctions, each intersection junction of which is shared with an adjacent planar reflector. The cube corner retroreflector has an interior portion that is a region of space surrounded on three sides by the planar reflectors.

Cube corner retroreflectors may be open-air cube corners or glass cube corners. Open-air cube corner retroreflectors have an interior portion of air, while the glass cube corner retroreflectors have an interior portion of glass. The glass cube corner retroreflector is a type of glass prism. One surface of the glass prism is distal to the vertex.

Each intersection junction may have a non-reflecting portion. A non-reflecting portion is formed on the junction to reduce or minimize the amount of light reflecting back into the laser tracker. The non-reflecting portion does not necessarily suppress all light that is reflected or scattered. Rather the non-reflecting portions are configured to greatly reduce the return of light to the tracker relative to the returning light reflected off of the three planar reflectors. The reduced return of light may be achieved by making the non-reflecting portion from (a) an absorbing material such as an absorbing coloration or an absorbing tape, (b) a scattering surface texture or material, (c) a curved reflective surface that results in a diverging pattern of light, or (d) a planar surface that reflects the light away from the laser tracker. Other methods for making the non-reflecting portion to achieve a reduced return of light may be utilized in light of the teachings herein, as should be apparent to one of ordinary skill in the art.

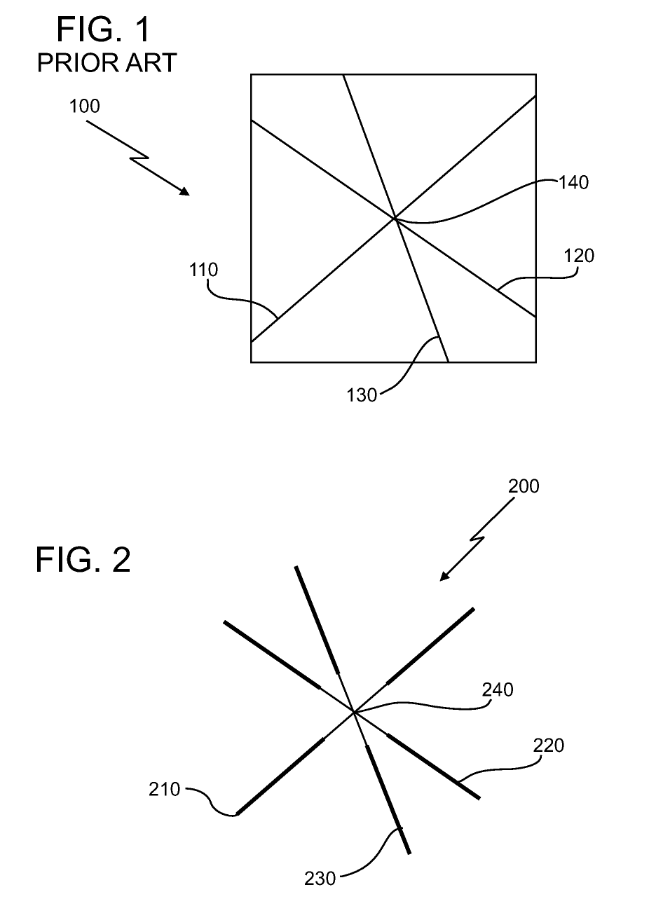

FIG. 1 illustrates an image pattern 100 in the prior art appearing on an orientation camera within a laser tracker. This pattern was shown previously in FIG. 12 of U.S. Pat. No. 7,800,758, which is incorporated by reference herein. The three lines 110, 120, 130 shown in FIG. 1 were obtained by illuminating a cube corner retroreflector onto which non-reflecting portions were placed or formed on each of the three intersection junctions of the three planar surfaces of the cube corner retroreflector. The vertex of the cube corner retroreflector corresponds to point 140 in FIG. 1. Each of the lines 110, 120, 130 extends on both sides of the point 140 because each non-reflecting portion blocks (relative to the laser tracker camera) laser light on the way into and on the way out of the cube corner.

A potential issue with non-reflecting portions placed on a cube corner retroreflector to produce the pattern of FIG. 1 is that a large amount of light may be blocked near the center of the retroreflector where the optical power is the highest. In some cases, the result of the reduced optical power returning to the laser tracker is a decrease in tracking performance and a decrease in the accuracy of distance and angle measurements by the laser tracker. To resolve this issue, the non-reflecting portions may be modified to produce a pattern 200 like that shown in FIG. 2. With non-reflecting portions placed on the intersection junctions in this manner, a relatively large amount of optical power is returned to the laser tracker, and yet the lines 210, 220, and 230 may be clearly observed by the orientation camera. In FIG. 2, the lines adjacent to the vertex point 240 are relatively narrow compared to the lines farther from the vertex.

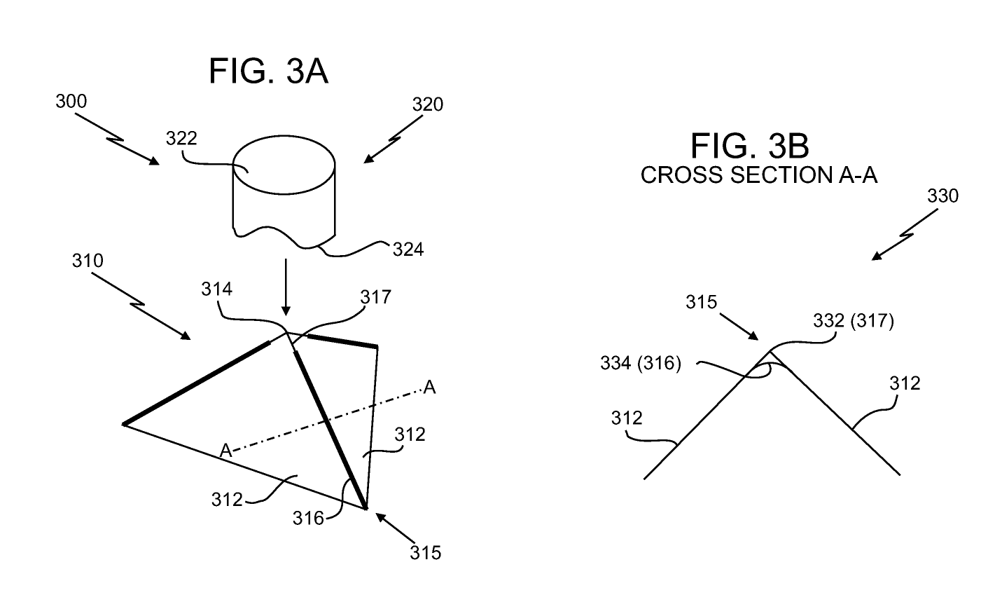

There are at least two common methods for making open-air cube corner retroreflectors: replication and assembly of glass panels. FIG. 3A shows both the general features of the replication process 300. A master element 310 is carefully machined to produce the characteristics desired in the final replicated retroreflector. For example, the master element 310 may be machined to make each of the three faces 312 almost exactly perpendicular to its two neighbors 312. For example, the faces 312 of the master element 310 may be perpendicular to each of its nearest neighbors to within one or two arc seconds. The master element 310 is coated with a reflective material such as gold. A cube corner slug 320 includes a machined blank 322 coated with a thin adhesive layer of material 324 such as epoxy. The cube corner slug 320 is brought in contact with the master element 310. In doing so, the epoxy layer is brought into conformance with the shape of the master element 310. After the epoxy cures and the slug 320 is lifted off the master element 310, the gold layer sticks to the epoxy, thereby providing the cube corner slug 320 with a reflective coating.

Usually, the intersection junctions of the master element 310 are not sharp. One reason for this lack of sharpness is the difficulty of machining such sharp intersection junctions. Another reason is that the intersection junctions tend to chip during repeated replications if the junctions are too sharp. Instead, the intersection junctions are usually rounded with a small fillet or angled with a small bevel. Usually, for cube corners that are placed in spherically mounted retroreflectors used to measure three degrees of freedom, these features are made as small as practical. For example, a fillet applied to the intersection junctions of master element 310 might have a radius of curvature of 0.003 inch. This radius of curvature is transferred to the intersection junctions of slug 320. The fillet or bevel applied to the cube corner retroreflector is a non-reflecting portion according to the explanation given hereinabove. In other words, very little light will return to the laser tracker after striking a fillet or bevel applied to the intersection junctions of the cube corner retroreflector.

If the cube corner retroreflector is to be used in conjunction with a system to measure six degrees of freedom similar to that described in U.S. Pat. No. 7,800,758, then it may be desirable to broaden the non-reflecting portions observed by the orientation camera within the laser tracker. If a six degree-of-freedom (DOF) target is only a few meters away from the tracker, then the narrow non-reflecting portions commonly present in high quality prior art SMRs may be wide enough to be easily seen by the orientation camera. However, if the six DOF target is located farther away—for example, up to 30 meters from the laser tracker—then the non-reflecting portions will need to be widened to make them visible on the orientation camera. For example, the non-reflecting portions might need to be about 0.5 mm wide to be clearly seen by the orientation camera.

In FIG. 3A, the non-reflecting portion 317 near the vertex 314 is narrower than the non-reflecting portion 316 farther from the vertex. By reproducing this combination of non-reflecting portions 315 on each of the three intersection junctions, a pattern like that of FIG. 2 is observed on the orientation camera within the laser tracker.

A way of implementing the combination of non-reflecting portions 315 is shown in FIG. 3B, which is a cross sectional view 330 taken through a planar slice A-A in FIG. 3A perpendicular to one of the intersection junctions. The non-reflecting portion 317 corresponds to a fillet 332 having a relatively small radius of curvature. The non-reflecting portion 316 corresponds to a fillet 334 having a relatively large radius of curvature. If desired, the fillets 332, 334 could be replaced by other shapes such as bevels. In general, the non-reflecting portions in the retroreflector slug 320 are obtained by adding additional material (e.g., epoxy) to the intersection junctions. This additional material may take such forms as fillets or bevels.

The second common method of making open-air cube corner retroreflectors is to join mirror panels into a cube-corner assembly. Three glass panels are joined together to be mutually perpendicular. There are slight gaps at the intersection regions between glass panels. Light that strikes the gaps is not reflected back to the laser tracker and so represents non-reflecting portions from the view point of the laser tracker camera. If thicker lines are desired, these may be obtained, for example, by (a) increasing the width of the gap, (b) coloring (darkening) the mirrors over the desired portions, or (c) attaching low reflection material (e.g., black adhesive tape) at the intersection junctions.

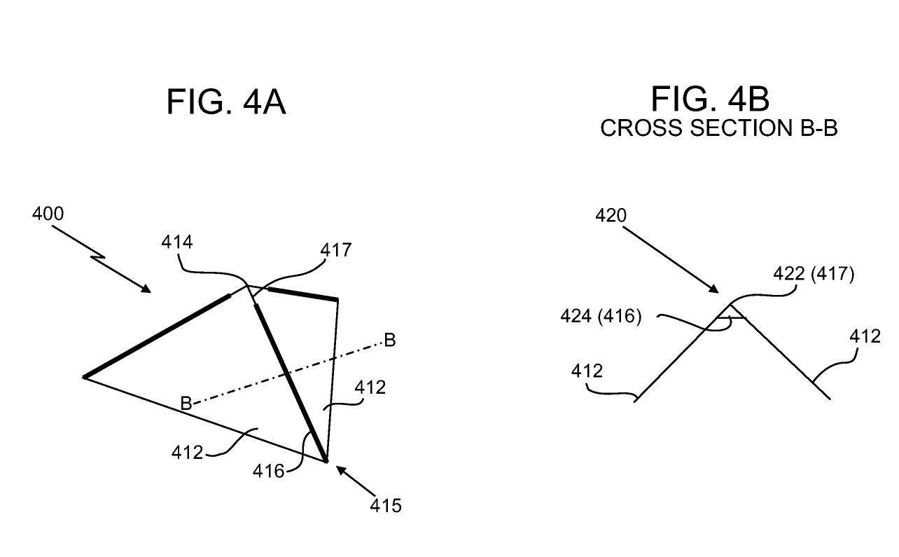

Referring now to FIG. 4A, a glass cube corner retroreflector 400 has planar reflectors 412 that are mutually perpendicular. The non-reflecting portions of glass cube corner retroreflector 400 shown in FIG. 4A are obtained by removing some of the glass along the intersection junctions. The non-reflecting portion 417 near the vertex 414 is thinner than the non-reflecting portion 416 farther from the vertex 414. This is shown in more detail in the cross-sectional view B-B of FIG. 4B. The relatively thin non-reflecting portion 417 corresponds to the relatively small bevel 422, and the relatively thick non-reflecting portion 416 corresponds to the relatively large bevel 424. If desired, the bevels 422, 424 could be replaced by other shapes such as fillets. In general, the non-reflecting portions in the glass cube corner prism 400 are obtained by removing glass at the intersection junctions. This removed material may take such forms as bevels or fillets. As discussed in more detail below, in one embodiment the material may be removed through a focused ion beam milling/etching or a laser ablation process that removes the reflective (e.g. gold) surface in the desired areas to form the non-reflecting portions.

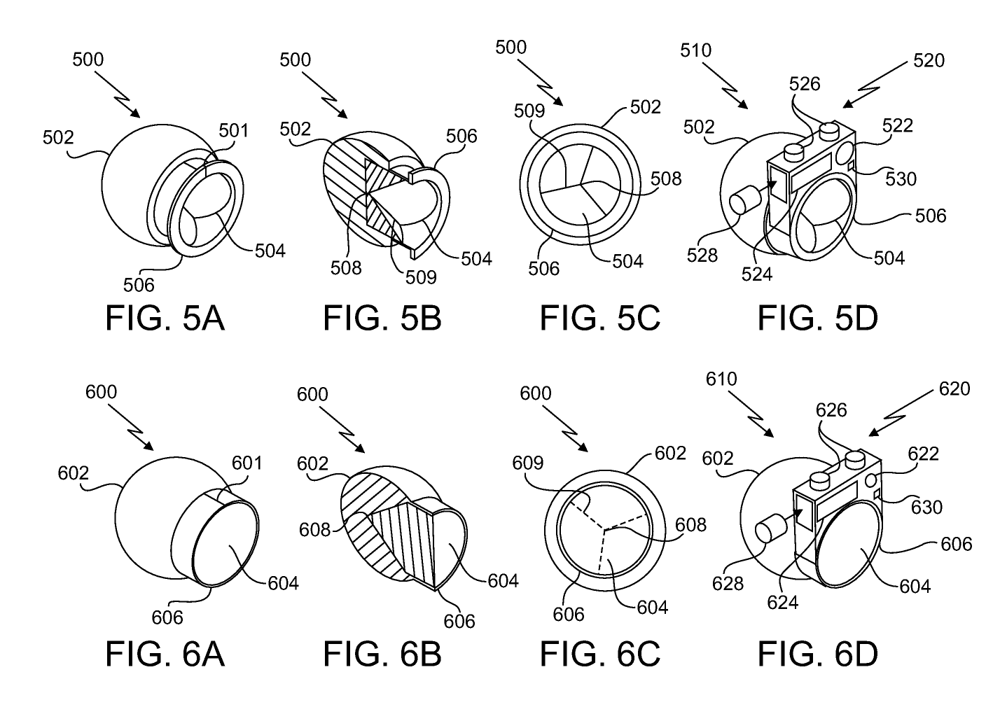

A cube corner retroreflector having non-reflecting portions may be embedded in a sphere, as shown in FIGS. 5A-D and 6A-D, or in a probe, as shown in FIG. 1 of U.S. Pat. No. 7,800,758. FIG. 5A shows a spherically mounted target 500 including a spherical body 502, an open-air cube corner retroreflector 504 with non-reflecting portions, a collar 506, and a reference mark 501. A cavity in the spherical body 502 is sized to accept the cube corner retroreflector 504. The cube corner retroreflector 504 is attached to the spherical body 502, such as with adhesive for example. The collar 506 provides protection for the cube corner retroreflector 504 and provides a convenient grip for the operator. The reference mark is used to establish a coarse reference orientation for the target 500. FIG. 5B shows a cross sectional view taken through the center of the spherically mounted target 500. The cross section reveals the open-air cube corner 504 to be of the replicated type, but a cube corner retroreflector formed of three mirror panels could equally well be used. FIG. 5C shows a front view of the spherically mounted target 500. The three intersection junctions 509 are visible about vertex 508.

FIG. 6A shows a spherically mounted target 600 including a spherical body 602, a glass cube corner retroreflector prism 604 with non-reflecting portions, a collar 606, and a reference mark 601. A cavity in the spherical body 602 is sized to accept the cube corner retroreflector 604. The cube corner retroreflector 604 is attached to the spherical body 602. The collar 606 provides protection for the cube corner retroreflector 604 and provides a convenient grip for the operator. The reference mark is used to establish a coarse reference orientation for the spherically mounted target 600. FIG. 6B shows a cross sectional view taken through the center of the spherically mounted target 600. FIG. 6C shows a front view of the spherically mounted target 600. The three intersection junctions 609 are beneath the top surface of the glass prism and so are shown as dashed lines about the vertex 608.

FIG. 5D shows an interface component 520 attached to spherically mounted target 500 to produce an enhanced spherically mounted target 510. Interface component 520 may contain a number of optional elements. One such optional element is a reference feature 522, which may be a retroreflector (e.g., a small glass cube corner retroreflector), a region of reflective material, or a target light (e.g., an LED). The retroreflector or region of reflective material may be illuminated by a light from the laser tracker and the image captured by a camera in the laser tracker to determine the coarse orientation of the target 510. In other embodiments, the target light may be illuminated and the image captured by a camera on the laser tracker to determine the coarse orientation of the target 510. The reference feature 522 may be left off altogether in which case the interface component 520 may itself serve as a reference mark. In this case, the operator aligns the target 510 in a prescribed orientation which is understood to be the coarse orientation.

Another optional element of interface component 520 is identifier element 524. The identifier element 524 may take the form of a bar-code pattern or an RF tag, for example. The tracker may read the contents of the bar code using a locator camera placed, for example, on the front of the tracker. The tracker may read the identity of the RF tag by illuminating the RF tag with radio frequency (RF) energy. The identifier element 524 may contain a serial number that identifies the particular target 510. Alternatively, it may contain one or more parameters that characterize the target 510.

Another optional element of interface component 520 is antenna 530. Antenna 530 may be used to send and/or to receive wireless data in the form of radio frequency signals. Such an antenna may be attached to a small circuit board that is powered by a small battery 528 that fits inside interface component 520. The small circuit board may be made of rigid-flex material which permits a very compact circuit to be enclosed within the interface component.

The interface component 520 may also be provided with one or more optional actuator buttons 526. The actuator buttons 526 may be used to start and stop measurements or to initiate a variety of other actions. These buttons may be used in combination with indicator lights on the laser tracker to ensure that the tracker has received the intended commands.

The interface component 520 may also contain a temperature sensor mounted within the target—for example, on the spherical body 502 or cube corner retroreflector 504. As the spherical body 502 and cube corner retroreflector 504 are heated or cooled, the position of the vertex 508 may shift since in general the spherical body 502 and cube corner retroreflector 504 may be made of different materials having different coefficients of thermal expansion (CTEs). By tracking the temperature of the cube corner retroreflector, a compensation may be performed to shift the position of the vertex 508 by an appropriate amount.

FIG. 6D shows an interface component 620 attached to spherically mounted target 600 to produce an enhanced spherically mounted target 610. Interface component 620 may contain a number of optional elements, which are analogous to the optional elements in the interface component 520. The optional elements 622, 624, 630, 628, and 626 have the same description as the optional elements 522, 524, 530, 528, and 526. Because of this, the descriptions will not be repeated here.

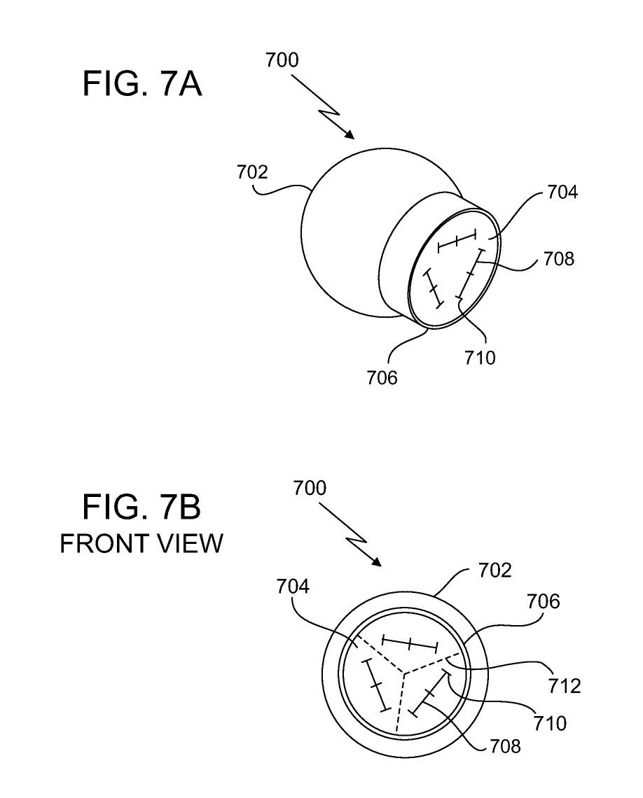

FIG. 7A is a perspective view of a spherically mounted target 700, which includes glass cube corner 704, spherical element 702, and collar 706. One or more non-reflecting marks 708 are placed on the top surface, which is the surface distal to the vertex, of the glass cube corner 704. In one embodiment, the marks are used to provide a way of determining the three degrees of orientational freedom even when the target is tilted to an extreme angle. In FIG. 7A, three such marks 708 are provided to enable the spherically mounted target 700 to be tilted to an extreme angle in any direction. The optional marks 710 provide a way to more accurately determine the roll angle of the target 700. FIG. 7B is a front view of spherically mounted target 700. In one embodiment, the marks 708 may be an etched mark that is formed through a focused ion beam etching process as discussed in more detail below.

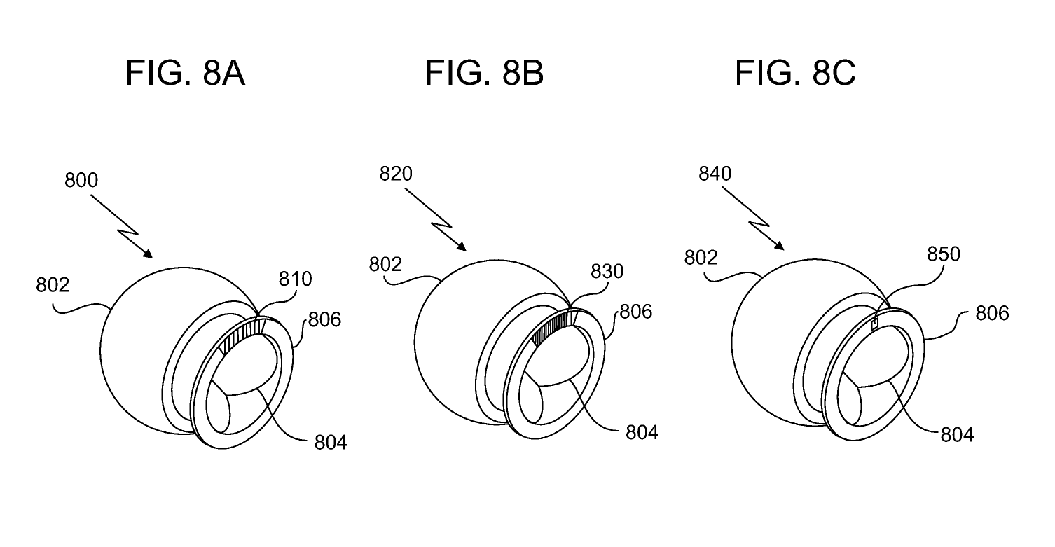

FIGS. 8A-C show three embodiments of spherically mounted targets. In FIG. 8A, the spherically mounted target 800 includes a spherical element 802, a cube corner retroreflector 804, and a collar 806. A region of reflecting material 810 is placed on the front surface of collar 806. This region of reflecting material 810 is illuminated by light from the laser tracker and its position is determined by a camera within the tracker. The position of the region 810 is used to find the coarse orientation of the spherically mounted target 800. In FIG. 8B, the spherically mounted target 820 includes the same elements as spherically mounted target 800 except that the region of reflecting material 810 is replaced by a bar code pattern 830. The bar code pattern 830 may serve to provide an identification of the target 820 and it may also act as a region of reflecting material to provide a coarse orientation of the target 820. In FIG. 8C, the spherically mounted target 840 includes the same elements as spherically mounted target 800 except that the region of reflecting material 810 is replaced by an RF identification chip 850. This chip 850 may be interrogated by an RF transmitter/receiver to obtain information about the spherically mounted target 840. This information may be a serial number or one or more parameters of the target 840.

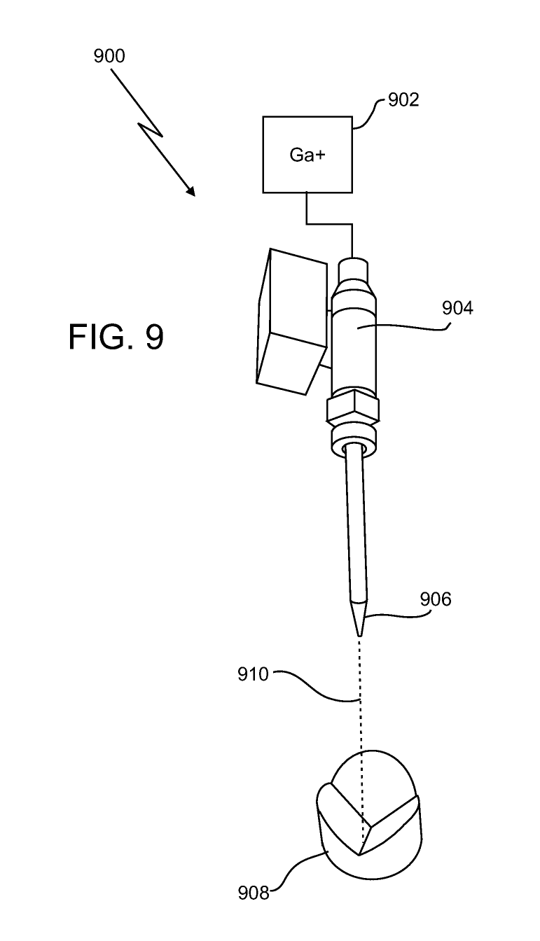

Referring now to FIG. 9, a system of forming the non-reflective portions is shown, such as non-reflecting portion 316 for example. In this embodiment, an ion-beam milling/etching apparatus 900 is provided. An ion-beam apparatus 900 uses a focused stream of ions to selective remove material from a target object. The apparatus 900 typically includes a liquid metal ion source 902, such as gallium (Ga+), Argon (Ar+) and Xenon (Xe+) for example. The liquid metal is placed into contact with a needle, made out of a material such as tungsten. The liquid metal flows through a tip where opposing forces of surface tension and an electric field cause ionization and field emission of the liquid metal atoms. The ions are accelerated to an energy level of 1-50 kiloelectronvolts and focused onto the target with a series of lenses 904, 906. Upon striking the target object the ions remove material from the surface of the target object. This material removal is performed without significant localized heating of the target object surface. In the exemplary embodiment, the apparatus 900 has a resolution of about 10 nanometers.

In the exemplary embodiment, the apparatus 900 is used to etch or mill the reflective surfaces of a cube-corner retroreflector to form a non-reflecting line having a substantially uniform width. The apparatus 900 may be used in two different processes to form the non-reflecting lines. In the embodiment such as that shown in FIG. 3A, the master element 310 is coated with a reflective material such as gold and coupled with an adhesive layer on a slug 320 to form a reflective coating. The slug with the reflective coating 908 is positioned on a fixture (not shown) adjacent the apparatus 900. The fixture aligns the intersections to receive a stream of ions 910. The impact of the ions on the surface removes the gold reflective layer at the intersections to form a nonreflective portion.

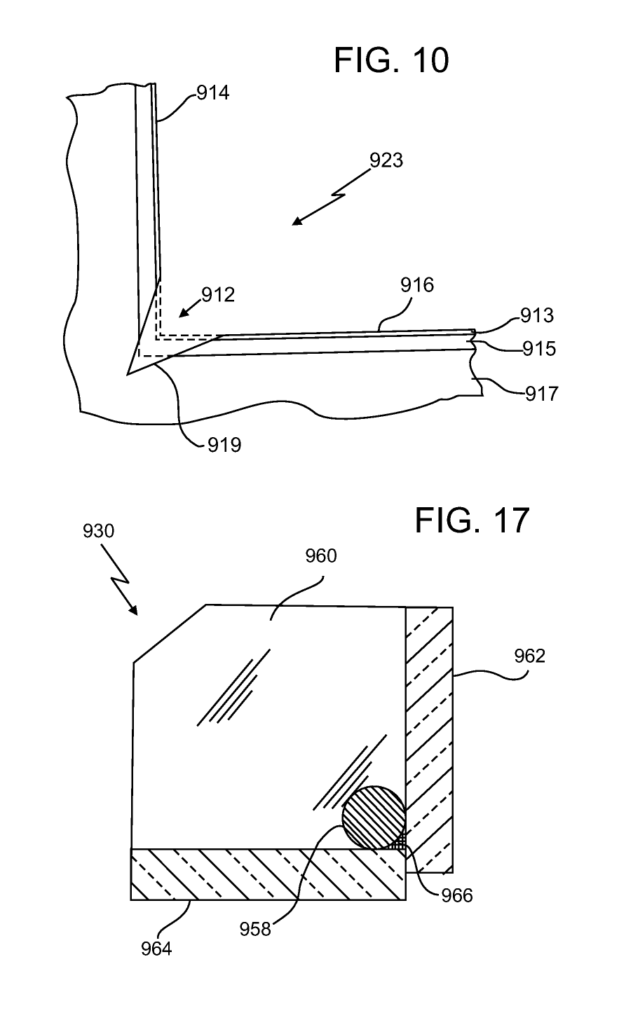

One advantage of ion milling/etching apparatus 900 is the ability to precisely remove small amounts of material. In one embodiment, the apparatus 900 has a resolution of about 5 nanometers. As a result, additional advantages may be gained by shaping the recess formed by the removed material. In one embodiment, shown in FIG. 10, the stream of ions 910 is used for form a wedge, a triangle or v-shaped recess 912 along a dihedral line of retroreflector 908 at the intersection of a first reflective surface 914 and a second reflective surface 916. In this embodiment, the recess 912 that tapers along walls 919 as the recess 912 approaches the surfaces 914, 916. Because the recess 912 does not provide a retroreflective surface, the recess 912 forms a non-reflective line from the viewpoint of the laser tracker camera.

It should be appreciated that the description of the recess 912 as being v-shaped is for exemplary purposes and other shaped recesses may also be used. In other embodiments, the recess 912 may include curved walls or may have faceted walls for example.

In an embodiment, the cube-corner retroreflector 908 is formed using the replication process discussed hereinabove. In this case, the outer layer of the retroreflector surface includes reflective layer 913 on each of the three planar surfaces of the cube corner. Below the reflective layer is an epoxy layer 915 that sits above a base layer that may be an aluminum slug, for example. In one embodiment, the recess 912 extends into both layers 915 and 917. In an alternative embodiment, the recess is shallower and penetrates only the epoxy layer. Of course, it would also be possible to apply a recess 912 directly to three glass panels adhered together rather than to the epoxy-aluminum combination.

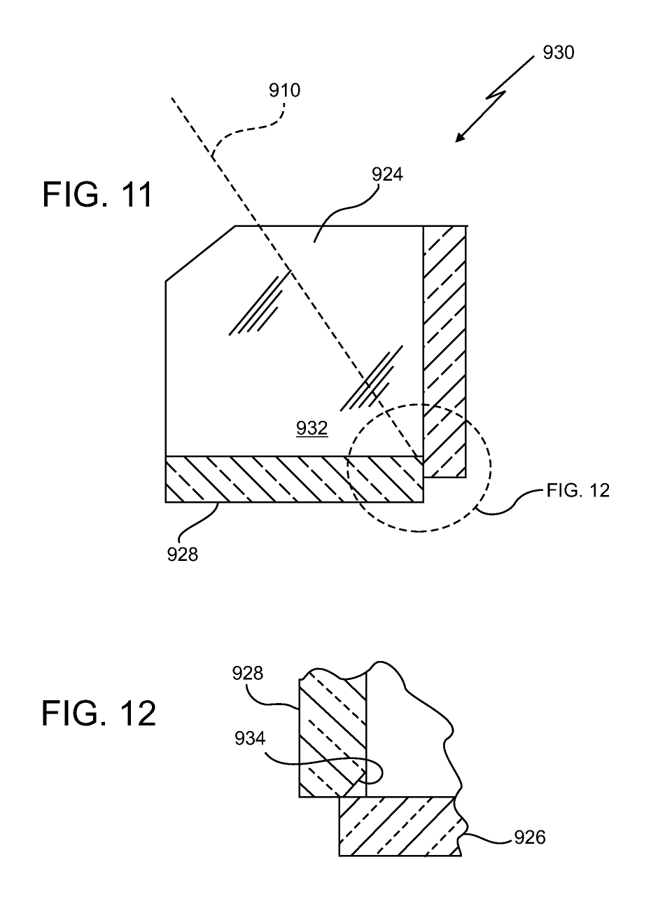

In another embodiment shown in FIG. 11 and FIG. 12 three glass reflective surfaces 924, 926,928 are joined together to form a cube-cornered retroreflector 930. The apparatus 900 then emits a stream of ions 910 which remove material from a corner 932 of a glass at each intersection (the dihedral line) to define a sharp edge 934 (FIG. 12). Similar to the embodiment of FIG. 10, since the removed surface will not reflect back incoming light toward the laser tracker, the removed edge forms a non-reflecting line from the viewpoint of the laser tracker camera. In one embodiment, the non-reflecting line has a width of 250 micrometers.

In another embodiment, ion milling/etching apparatus 900 is replaced with a laser, such as a Nd:YAG (neodumium YAG) laser. In this embodiment, a laser beam is directed at the dihedral line in a similar manner to the ions from the apparatus 900. The impingement of the laser beam on the intersection of the reflective surfaces may be used to ablate materials from the surface of the cube-cornered retroreflector 930 such as the gold coating or the underling adhesive layer. As discussed herein above, the ablation of the material removes the reflective coating and creates a non-reflective mark. In the exemplary embodiment, the laser has an optical wavelength of 1.064 micrometers and the non-reflective mark is 250 micro meters wide.

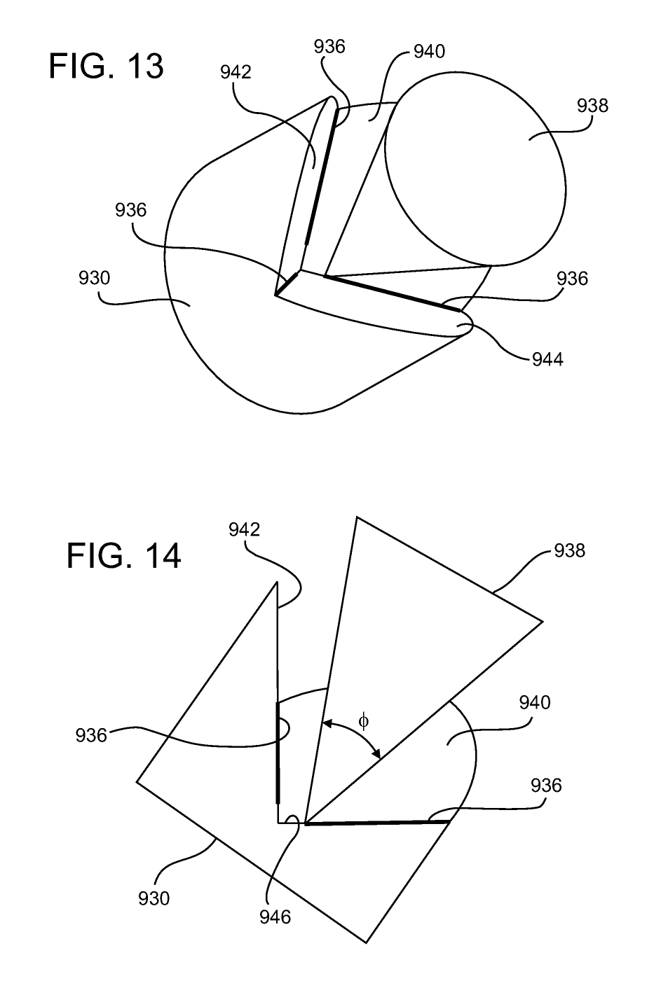

Referring now to FIG. 13 and FIG. 14 another embodiment is illustrated for forming the non-reflective marks on a cube-cornered retroreflector. In this embodiment, the non-reflective marks 936 are formed using a micro-machining process, such as a single point diamond turning for example. This process allows for the mechanical removal of material, such as the gold layer, the adhesive layer or the corner of the glass to form a line or area that does not reflect light back towards the laser tracker camera. In one embodiment, the micro-machining process has a resolution of 10 nanometers. The micro-machining process may include a cutting tip 938 having a conical shape having an included angle φ. The angle φ is less than 90 degrees to allow the cutting tip 938 to be inserted into the area defined by the three surfaces 940, 942, 944 of the cube cornered retroreflector 930. As discussed herein above, the non-reflective marks 936 may only extend a portion of the length of the line formed by the intersection of the glass surfaces (the dihedral line) such that the length of portion 946 of the intersection is smaller than the length of the non-reflective mark 936.

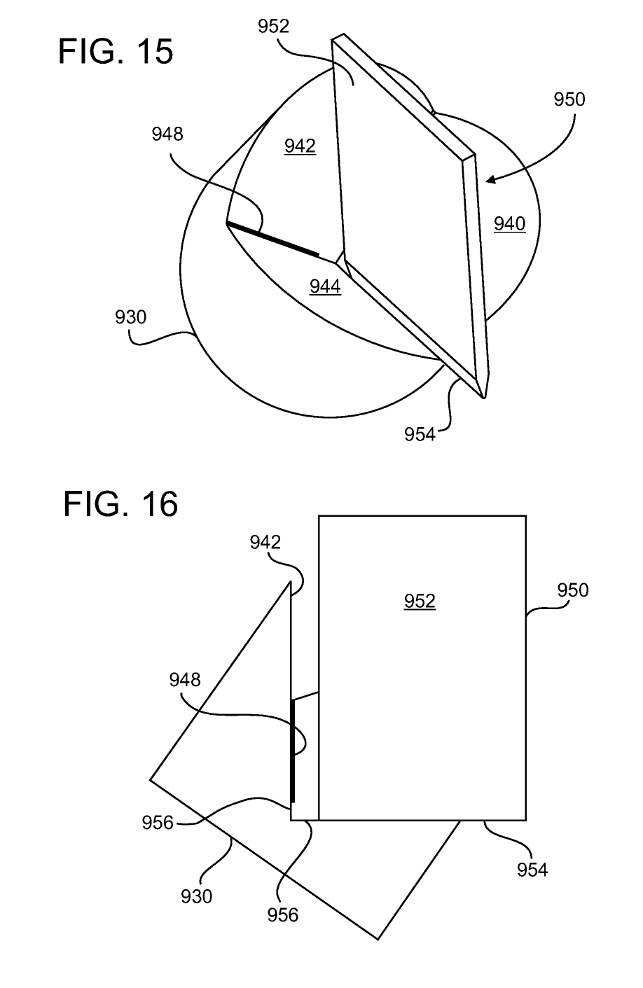

Referring now to FIG. 15 and FIG. 16, another embodiment is illustrated for forming non-reflective marks 948 in a cube cornered retroreflector 930 using knife-edge stamping. In this embodiment, a die 950 is provided having a body portion in the shape of a flat plate 952, the body has a thin thickness (relative to the length and width of the body). Arranged on one end, a wedge shaped cutting edge 954 is provided. The die 950 is arranged in the area formed by the three surfaces 940, 942, 944 of the cube cornered retroreflector 930. The cutting edge 954 is positioned on the intersection of the glass surfaces (the dihedral line) and pressed into the intersection to remove corner of the glass surface. Similar to the embodiment of FIG. 12, with the corner of the glass surface removed, the incoming light is not reflected back toward the tracker camera to form a non-reflective mark. In some embodiments, the die 950 is positioned such that a portion 956 of the intersection remains with a sharp corner.

Referring now to FIG. 17, another embodiment is illustrated where the non-reflective markings are formed using optical fibers 958 attached along the intersection of each of the reflective surfaces 960, 962, 964. It should be appreciated that the reflective surfaces may be either a reflective coating or formed by planar glass members. In this embodiment, optical fibers have a low optical reflectance and a small radius of curvature. As a result, any incoming light is reflected from the surface of the optical fiber and is spread or diffused at a large angle, substantially reducing the amount of light reaching the laser tracker camera. The optical fiber 958 may be attached to the glass surfaces using an adhesive 966 that is either applied to the optical fiber 958 or intersection of the respective glass surfaces 960, 962, 964. In one embodiment, the adhesive 966 is a ultraviolet cured cement. Once the adhesive 966 is cured, the optical fiber may be cleaved at the end of the glass surfaces 960, 962, 964. In one embodiment, the end of the optical fiber 958 adjacent the vertex of the glass surfaces 960, 962, 964 may be cleaved with a sharp edge to allow the optical fibers on each of the three intersections to be placed with an end at the vertex. It should be appreciated that this allows the nonreflecting mark/line to extend along the entire length of the intersection of the glass surfaces 960, 962, 964 or any portion thereof. In one embodiment, the optical fiber has a diameter of 250 micrometers. In one embodiment, the optical fiber is a carbon fiber.

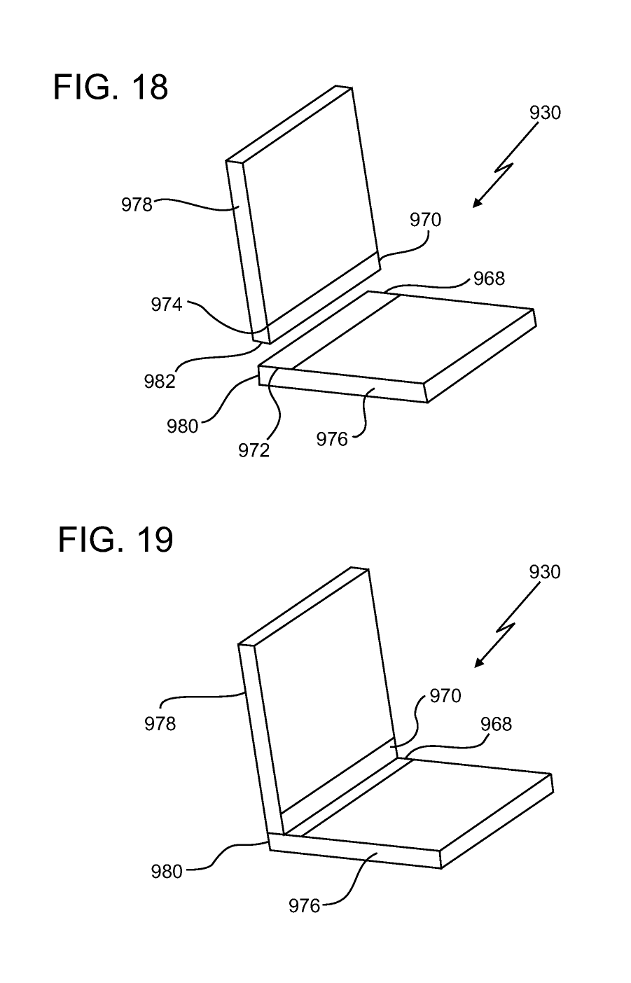

Referring now to FIG. 18 and FIG. 19, another embodiment is shown for forming non-reflecting marks on the dihedral line of a cube-corner retroreflector 930. In this embodiment, a non-reflecting stripe 968, 970 is applied to the edge 972, 974 of the glass panels 976, 978. In the exemplary embodiment, the non-reflecting stripes 968, 970 are formed as a thin-film anti-reflective type coating. The thin-film coating may be applied using a suitable technique, such as evaporative methods and sputtering. The thin film stripe 968, 970 may be configured to have a low reflectance at a narrow band of wavelengths, such as the wavelength of the laser from the laser tracker for example. In other embodiments, the thin-film strip 968, 970 may be anti-reflective for a wide band of wavelengths.

In one embodiment, the stripes 968, 970 may be applied to the entire surface of the glass panel. The reflective coating (e.g. gold or silver) is then applied, with a mask being used to define the stripe. In one embodiment, a beam blocking agent, such as an absorptive black paint may be applied to the back of the glass panel. In another embodiment, the surface of the glass panel is coated with the reflective coating first and then the non-reflective stripe is applied over the reflective coating. In this embodiment, the non-reflective stripe may be applied using a photolithographic method, such as a chrome-on-glass. A photoresist is applied to the surface and then exposed to light. The photoresist may be a negative, meaning the exposure to light causes the resist to be removed. The expose region is then coated with chrome. In still another embodiment, the stripes 968, 970 are formed by etching (such as with the ion-beam etching for example). By forming a roughened surface, the stripe area will appear dark on the image acquired by the laser tracker camera.

It should be appreciated that while FIGS. 18-19 only show two glass panels 976, 978 this is for clarity and the cube-cornered retroreflector 930 would include three panels with the non-reflecting stripes being applied along the intersecting edges of each glass panel. In the exemplary embodiment, the non-reflecting stripe 968 extends from the end 980 and has a width that is larger than the thickness of the adjoining glass panel. In other words, the overlap between the non-reflecting stripe 968 and the adjacent glass panel 978 covers at least a substantial portion of the end 982 of glass panel 978. It should be appreciated that while the embodiment shown in FIG. 18 and FIG. 19 illustrate the stripes 968, 970 extending along the entire length of the glass panels 976, 978, this is for exemplary purposes and the claimed invention should not be so limited. In other embodiments, the non-reflecting strips 968, 970 extend along only a portion of the edges 972, 974 such that the portion of the edge 972, 974 adjacent the vertex is un-marked and fully reflective as discussed in more detail herein above.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
directing ions from a focused ion beam etching (FIBE) device onto the first intersection junction defined by the first planar reflector and second planar reflector; and
removing a first material from at least a first portion of the first intersection junction to define a first non-reflecting portion.

2. The method of claim 1 wherein the step of removing the first material includes:
removing a second portion of the first planar reflector at the first intersection junction;
removing a third portion of the second planar reflector at the first intersection junction; and
wherein the first portion and second portion define the first non-reflecting portion.

3. The method of claim 1 wherein the first intersection junction includes a surface between the first planar reflector and the second planar reflector and the step of removing the first material includes removing material from a portion of the surface.

4. The method of claim 3 wherein the surface is a fillet.

5. The method of claim 4 wherein the surface is a chamfer.

6. The method of claim 1 wherein the step of removing the first material includes removing a first amount of material from the center of the first non-reflecting portion and a second amount of material from an area adjacent an edge of the first non-reflecting portion, the first amount being larger than the second amount.

7. The method of claim 6 wherein the step of removing the first material removes a v-shaped cross-sectional area of the first non-reflecting portion.

8. The method of claim 1 further comprising directing ions from the FIBE device onto the second intersection junction defined by the second planar reflector and the third planar reflector and removing a second material from at least a second portion of the second intersection junction to define a second non-reflecting portion.

9. The method of claim 8 further comprising directing ions from the FIBE device onto the third intersection junction defined by the first planar reflector and the third planar reflector and removing a third material from at least a third portion of the third intersection junction to define a third non-reflecting portion.

10. The method of claim 9 wherein the first non-reflecting portion is wider than the second non-reflecting portion and the third non-reflecting portion.

11. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
directing laser onto the first intersection junction defined by the first planar reflector and second planar reflector; and
ablating a first material with the laser from at least a first portion of the first intersection junction to define a first non-reflecting portion.

12. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
providing a micro-machining device having a cutting tip;
positioning the cutting tip onto the first intersection junction defined by the first planar reflector and second planar reflector; and
removing a first material with the cutting tip from at least a first portion of the first intersection junction to define a first non-reflecting portion.

13. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
providing an optical fiber having a diameter;
disposing the optical fiber onto the first intersection junction defined by the first planar reflector and second planar reflector; and
disposing an adhesive layer between the optical fiber and the first intersection junction.

14. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
directing a cutting edge from a knife-edge die onto the first intersection junction defined by the first planar reflector and second planar reflector; and
removing a first material with the cutting edge from at least a first portion of the first intersection junction to define a first non-reflecting portion.

15. A method of manufacturing a cube corner retroreflector, the method comprising:
providing the cube cornered retroreflector, the cube cornered retroreflector including a first planar reflector, a second planar reflector and a third planar reflector, each planar reflector capable of reflecting light, each planar reflector perpendicular to the other two planar reflectors, each planar reflector intersecting the other two planar reflectors in a common vertex, and each planar reflector having two intersection junctions, each intersection junction shared with an adjacent planar reflector for a total of three intersection junctions within the cube corner retroreflector, the three intersection junctions including a first intersection junction, a second intersection junction and a third intersection junction;
applying a first non-reflective stripe to a first edge of the first plan reflector adjacent the first intersection junction, the first non-reflective stripe having a first width greater than the thickness of the second planar reflector; and
applying a second non-reflective strip to the second planar reflector adjacent the first intersection junction, the second non-reflective stripe having a second width, the second width being smaller than the first width.

16. A retroreflector comprising:
a first planar region, a second planar region and a third planar region, wherein each planar region is perpendicular to the other two planar regions, each planar region intersects the other two planar regions in a common vertex, there being a first intersection junction between the first planar region and the second planar region, a second intersection junction between the second planar region and the third planar region, and a third intersection junction between the third planar region and the first planar region, the first planar region including a first reflective portion and a first non-reflective portion, the second planar region including a second reflective portion and a second non-reflective portion, the third planar region including a third reflective portion and a third non-reflective portion;
wherein an interior volume bound at least in part by the first planar region, the second planar region, and the third planar region is filled with air;
wherein the first reflective portion has a first reflective layer, the second reflective portion has a second reflective layer, and the third reflective portion has a third reflective layer, the first reflective layer, the second reflective layer, and the third reflective layer being applied to a substrate structure; and
wherein, in the first non-reflective portion, the second non-reflective portion, and the third non-reflective portion, the substrate structure is in contact with the air of the interior volume, the first non-reflective portion, the second non-reflective portion, and the third non-reflective portion each including a recess surface that lies within the substrate structure.

17. The retroreflector of claim 16 wherein a part of the first non-reflective portion coincides with the first intersection junction, a part of the second non-reflective portion coincides with the second intersection junction, and a part of the third non-reflective portion coincides with the third intersection junction.

18. The retroreflector of claim 16 wherein the substrate structure is a single component that includes a first material and a second material, the first material in contact with the first reflective portion, the second reflective portion, and the third reflective portion, and the second material in contact with the first material.

19. The retroreflector of claim 18 wherein the first material is epoxy.

20. The retroreflector of claim 19 wherein the second material is aluminum.

21. The retroreflector of claim 18 wherein, in the first non-reflecting portion, the second non-reflecting portion, and in the third non-reflecting portion, the first material is in contact with the air of the interior volume.

22. The retroreflector of claim 16 wherein the substrate structure includes a first panel, a second panel, and a third panel.

23. The retroreflector of claim 22 wherein the first panel, the second panel, and the third panel are made of glass.

24. The retroreflector of claim 16 wherein the first reflective layer, the second reflective layer, and the third reflective layer are selected from the group consisting of gold and protected silver.

25. The retroreflector of claim 16 wherein the first non-reflective portion, the second non-reflective portion, and the third non-reflective portion are line segments.

26. The retroreflector of claim 25 wherein the first non-reflective portion, the second non-reflective portion, and the third non-reflective portion each have a width of at least 100 micrometers.

27. The retroreflector of claim 25 wherein the first non-reflective portion includes a first linear region and a second linear region, the first linear region being wider than in the second linear region.
